(19) United States
(12) Patent Application Publication
(10) Pub. No.: US 2026/0061896 A1
(43) Pub. Date: Mar. 5, 2026

(54) MECHANICALLY-LINKED SEATING

(71) Applicant: Universal City Studios LLC, Universal City, CA (US)

(72) Inventors: Robert Andrew Rodrigues, Kissimmee, FL (US); Sarah Anne Kelley, Orlando, FL (US)

(21) Appl. No.: 18/817,021

(22) Filed: Aug. 27, 2024

(51) Int. Cl. B60N 2/14; A63G 7/00; B60N 2/01; B60N 2/24

(52) U.S. Cl. CPC B60N 2/14; B60N 2/01; B60N 2/24; A63G 7/00

(57) ABSTRACT

An amusement ride includes multiple seats disposed in at least one row. A first linkage pivotably couples to each seat, and a second linkage pivotably couples to each seat. The amusement ride also includes a coupling that couples the first linkage to the second linkage. In some embodiments, multiple couplings may be used to couple the first linkage to the second linkage at each location that the first linkage is pivotably coupled to each seat and at each location that the second linkage is pivotably coupled to each seat. The coupling is configured to enable the first linkage to move relative to the second linkage.

### BACKGROUND

The present disclosure relates generally to seating of an amusement ride.

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Some amusement rides, such as flying theater ride systems, may include one or more rows of multiple seats for multiple guests to sit. The seats may share a pivot point, enabling the seats to move about the pivot point and simulate a ride experience. However, this prevents individualization of the ride experience (e.g., a sensation of flight), in that the multiple seats in a row sharing a pivot point are limited to moving together. Moreover, a degree of rotation about the pivot point may be limited due to a severity of the rotation being exacerbated on ends of a row of seats. As such, it may be recognized that an improved seating system for amusement rides is desired.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from embodiments set forth below.

In an embodiment, an amusement ride includes multiple seats, a first linkage pivotably coupled to each seat, and a second linkage pivotably coupled to each seat. The amusement ride also includes a coupling that couples the first linkage to the second linkage. The coupling is configured to enable the first linkage to move relative to the second linkage.

In an embodiment, an amusement ride system includes multiple seats, a first linkage coupled to each seat, and a second linkage coupled to each seat. The amusement ride system also includes an actuator coupled to the first linkage and configured to move the first linkage relative to the second linkage

In an embodiment, an amusement ride system includes a first row of seats rotatably coupled to one another via a first set of linkages, and a second row of seats rotatably coupled to one another via a second set of linkages. The amusement ride system also includes a structure coupling a first linkage of the first set of linkages to a second linkage of the second set of linkages.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective diagram of a front view of an amusement ride system having a row of multiple seats, according to an embodiment of the present disclosure;

FIG. 2 is a perspective diagram of a front view of the amusement ride system of FIG. 1 pivoted to an operating position, according to an embodiment of the present disclosure;

FIG. 3 is a perspective diagram of a rear view of the amusement ride system of FIG. 1, according to an embodiment of the present disclosure;

FIG. 4 is a perspective diagram of an amusement ride system having one linkage and no couplings, according to an embodiment of the present disclosure;

FIG. 5 is a perspective diagram of the amusement ride system of FIG. 1 having multiple rows, according to an embodiment of the present disclosure; and

FIG. 6 is a perspective diagram of a seat of the amusement ride system of FIG. 1, according to an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure relates generally to amusement rides, such as flying theater ride systems. Such rides may include one or more rows of multiple seats for multiple guests to sit. The seats may share a pivot point, enabling the seats to move about the pivot point and simulate a ride experience. However, this prevents individualization of the ride experience (e.g., a sensation of flight), in that the multiple seats in a row sharing a pivot point are limited to moving together. Moreover, a degree of rotation about the pivot point may be limited due to a severity of the rotation being exacerbated on ends of a row of seats.

The presently disclosed systems and devices include an amusement ride having multiple seats disposed in at least one row. A first linkage pivotably couples to each seat at a pivot point. The first linkage may also couple to a base structure or second linkage. In some embodiments, the amusement ride may also include a coupling that couples the first linkage to the second linkage. The coupling is configured to enable the first linkage to move relative to the second linkage.

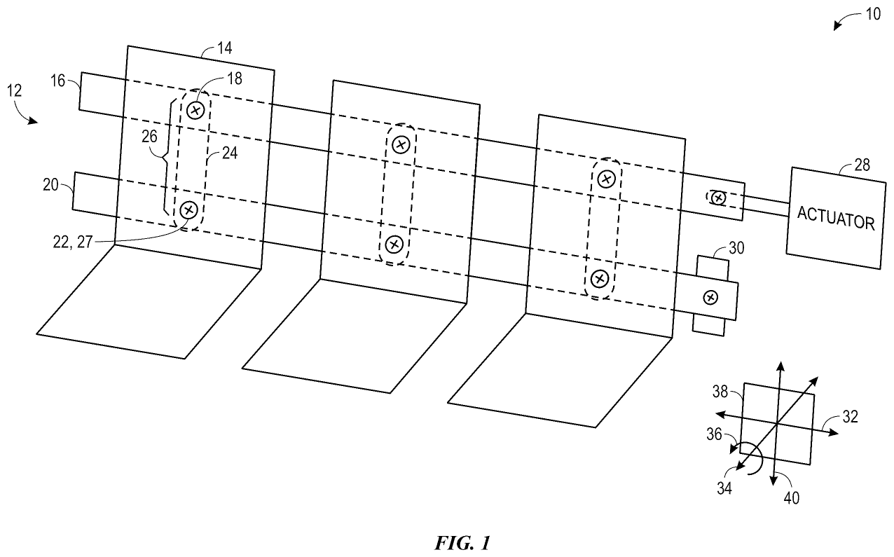

By way of introduction, FIG. 1 is a perspective diagram of a front view of an amusement ride system 10 having a row 12 of multiple seats or chairs 14, according to an embodiment of the present disclosure. Each row 12 may include a first linkage, beam, rail, bar, or linkage 16 pivotably or rotatably coupled to each seat 14 (e.g., to a rear portion or surface of each seat 14) via a first joint 18, and a second linkage, beam, rail, bar, or linkage 20 pivotably or rotatably coupled to a pivot point each seat 14 via a second joint 22. As illustrated, the first linkage 16 and the second linkage 20 may be straight or linear, though in additional or alternative embodiments, the first linkage 16 and/or the second linkage 20 may curve or be arcuate. The first joint 18 and the second joint 22 may include any suitable joint that pivotably or rotatably couples the seat 14 to the first linkage 16 and/or the second joint 22, such as a shaft (in conjunction with bearing or without bearings), cardan joint, union joint, fastener, screw, bolt, rivet, and so on. A coupling 24 may pivotably or rotatably couple to the first joint 18 and the second joint 22, such that the first joint 18 may rotate relative to the second joint 22, while maintaining a distance 26 between the first joint 18 and the second joint 22.

While the row 12 is illustrated as having three seats 14, it should be understood that there may be more or fewer seats 14 (e.g., four seats or more, eight seats or more, ten seats or more, 12 seats or more, 2 seats or less, and so on) in the row. Additionally, while two linkages 16, 20 are illustrated, it should be understood that additional linkages (e.g., beams, rails, or bars) are contemplated, which would also be pivotably or rotatably coupled to the seats 14 via additional joints. To enable pivoting the seats 14 about a pivot point 27 (e.g., the second joint 22), a first linkage (e.g., the first linkage 16) may be coupled to an actuator 28, while a second linkage (e.g., the second linkage 20) may be fixed. For example, the second linkage 20 is shown to be coupled to a fixed base 30. The actuator 28 may include any suitable actuator to move the first linkage 16 relative to the second linkage 20, such as a linear actuator, a hydraulic actuator, an electric actuator, a rotary actuator, a rotary motor, a pneumatic actuator, an electromagnetic actuator, and so on.

In particular, the actuator 28 may apply a force to the first linkage 16 to move (e.g., push and/or pull) the first linkage 16 along a horizontal axis 32 (e.g., in a direction along the row 12 of the seats 14) transverse, orthogonal, or normal to a front-facing axis 34 (e.g., in a direction of a guest's view) of the amusement ride system 10, the row 12, and/or the seats 14. This may cause each seat 14 to pivot in a rotational direction 36 about the front-facing axis 34 along a plane 38 that is defined by the horizontal axis 32 and a vertical axis 40 of the seats 14 (e.g., that intersects both the first linkage 16 and the second linkage 20) and is transverse, orthogonal, or normal to the front-facing axis 34). That is, the actuator 28 may pivot or rock each seat 14 from side-to-side or from one side of the seat 14 to the other side of the seat 14 along the plane 38 and about the front-facing axis 34 extending from a respective pivot point 27.

FIG. 1 illustrates the seats 14 in a vertically straight position with respect to the vertical axis 40. As such, the amusement ride system 10 may be in a resting, loading, or unloading position, such that guests may load to or unload from the seats 14. During operation of the amusement ride system 10, which may be performed at least in part by the actuator 28, the seats 14 may pivot about the pivot point 27. In some embodiments, a controller having processing circuitry (e.g., one or more processors) that executes software programs and/or instructions stored in communicatively coupled memory device may control the actuator 28.

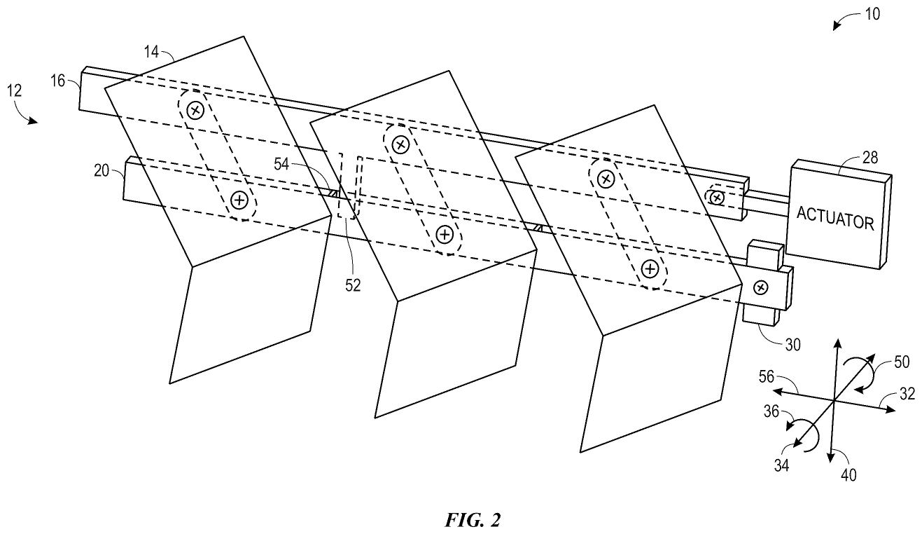

FIG. 2 is a perspective diagram of a front view of the amusement ride system 10 pivoted to an operating position, according to an embodiment of the present disclosure. In particular, the actuator 28 may extend from a first position illustrated in FIG. 1 to a second position illustrated in FIG. 2 along the horizontal axis 32, causing the first linkage 16 to move or shift along the horizontal axis 32 relative to the second linkage 20. The second linkage 20 may remain in its position illustrated in FIG. 1 due to being fixed to the base 30. That is, the second linkage 20, because it is fixed to the base 30, may stay fixed at its position, even when the actuator 28 moves the first linkage 16. Moving the first linkage 16 relative to the fixed second linkage 20 may cause each seat 14 to pivot uniformly in the same rotational direction 36 about the pivot point 27. Since both the first linkage 16 and the second linkage 20 are parallel, each seat 14 may pivot the same rotational amount or degree. In additional or alternative embodiments, the linkages 16, 20 may not be parallel, and or one or both of the linkages 16, 20 may not be straight (e.g., be curved or actuate), enable a different degree of rotation for each seat 14. This may enable certain seats 14 in the row 12 (e.g., at or toward an end of the row 12) to rotate a greater degree of rotation than other seats 14 in the row 12 (e.g., at or toward a center of the row 12), making it convenient to sit guests that are more motion-sensitive (e.g., children, older guests, physically challenged guests) in the seats 14 with a lesser degree of rotation. Similarly, the actuator 28 may retract to a third position, causing the seats to pivot in an opposite rotational direction 50 relative to the rotational direction 36.

As shown, in operation, the first linkage 16 extends in the direction of extension 56 with respect to the second linkage 20. In some embodiments, an end of the first linkage 16 that extends in the direction of extension 56 may be disposed in a receptacle or slot (e.g., in a wall or structure) to hold the amusement ride system 10 in place, to create an illusion that the linkages 16, 20 have not move with respect to one another, to prevent extension of the end of the first linkage 16 from unintentional contact, and so on.

In some embodiments, the amusement ride system 10 may include one or more stopping components that prevent the seats 14 from excessive rotation. For example, the first linkage 16 may include a protrusion 52, and the second linkage 20 may include a stopping point 54, such that, when the actuator 28 extends the first linkage 16 sufficiently far in a direction of extension 56, rotating the seat 14 to the position shown in FIG. 2, the protrusion 52 may contact the stopping point 54. The actuator 28 may not extend the first linkage 16 further as the stopping point 54 prevents the protrusion 52 from further moving in the direction of extension 56. It is contemplated that another set of stopping components may be disposed on an opposite side to prevent excessive rotation of the seats 14 in the opposite direction. Moreover, the protrusion 52 and the stopping point 54 are only examples of stopping components, and any suitable components that may stop excessive rotation of the seats 14 is contemplated, including using bumpers, biasing components, springs, a controller programmed to prevent rotation of the seats 14 at a threshold rotational degree, and so on.

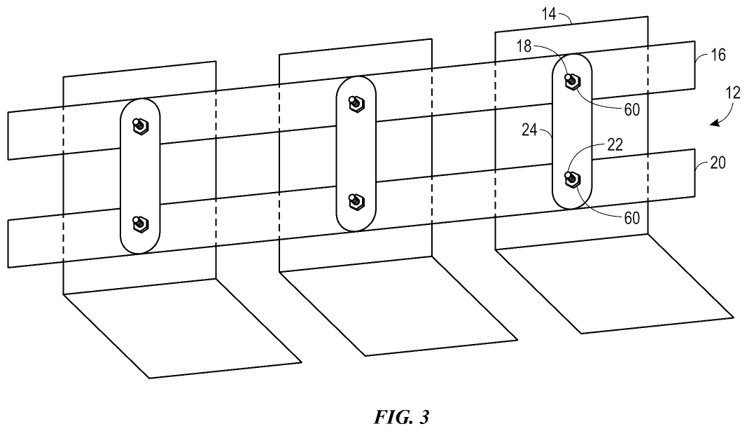

FIG. 3 is a perspective diagram of a rear view of the amusement ride system 10 of FIG. 1, according to an embodiment of the present disclosure. As illustrated, the couplings 24 are disposed between the seats 14 and the linkages 16, 20, though in additional or alternative embodiments, the linkages 16, 20 may be disposed between the couplings 24 and the seats 14. Nuts 60, washers, and/or other fastening equipment may be used to ensure that the joints 18, 22 do not disengage unintentionally and/or to ensure coupling between the couplings 24 and the joints 18, 22.

In additional or alternative embodiments, a lesser or greater number of couplings 24 may be used (e.g., two or more couplings 24, four or more couplings 24, six or more couplings 24, ten or more couplings 24, and so on). Indeed, the number of couplings 24 in the row 12 may be less than or more than the number of seats 14 in the row 12. In some embodiments, the couplings 24 may not couple to the seats 14 via the joints 18, 22, but instead couple to the first linkage 16 and the second linkage 20 at places where there are no seats 14 (e.g., between two seats 14, or at outer edges of the first linkage 16 and the second linkage 20 such that there is only one seat 14 adjacent to a coupling 24). For example, the amusement ride system 10 may be implemented as a four-bar linkage, where only two couplings 24 may couple the first linkage 16 and the second linkage 20 together (e.g., via the joints 18, 22 that couple two seats 14 to the first linkage 16 and the second linkage 20, or at places on the first linkage 16 and the second linkage 20 where there are no seats 14).

While a parallel motion linkage system is implemented by the amusement ride system 10, in additional or alternative embodiments, any suitable system may be used to move the first linkage 16 relative to the second linkage 20 to enable the seats 14 to pivot, such as a rack-and-pinion system. In cases where a rack-and-pinion system is used, different gearing may be engaged and disengaged or switched in and out to provide different degrees of rotation. For example, the actuator 28 may include a rotary motor that turns a pinion or gear, and the first linkage 16 may include a rack that engages the pinion. Multiple pinions of different sizes or number of teeth may be engaged or disengaged (e.g., by a controller or manually) to enable different degrees of rotation. For example, a larger gear may be engaged to enable a larger degree of rotation for adult guests, while a smaller gear may be engaged to enable a smaller degree of rotation for children, smaller guests, or more motion-sensitive guests.

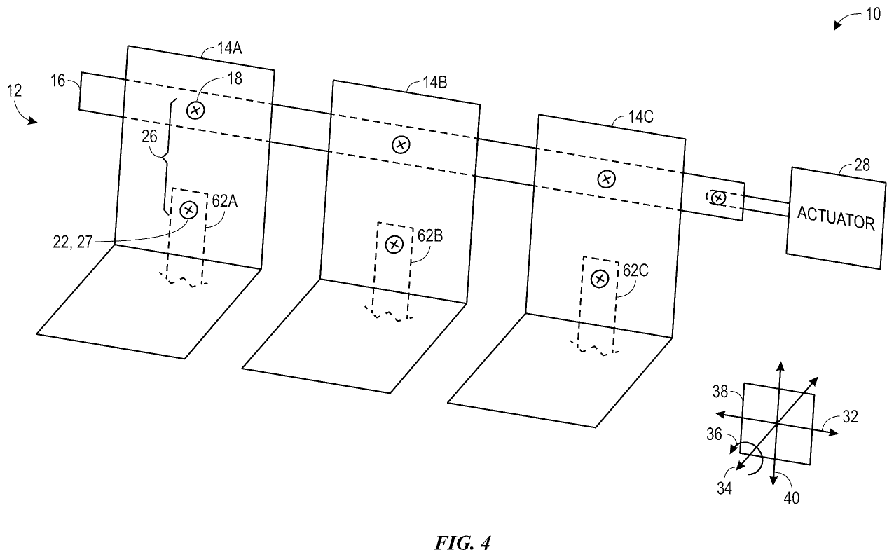

While the amusement ride systems 10 of FIGS. 1-3 show two linkages 16, 20, it should be understood that, in some embodiments, there may be only one linkage (e.g., 16), and the seats 14 may be fixed in place via other structures, as opposed to a second linkage 20. Likewise, while the amusement ride systems 10 of FIGS. 1-3 show the linkages being attached together by couplings 24 corresponding to each seat 14, it should be understood that less or indeed no couplings 24 may be used by the amusement ride systems 10. For example, FIG. 4 is a perspective diagram of the amusement ride system 10 having one linkage 16 and no couplings, according to an embodiment of the present disclosure. As illustrated, instead of the second linkage 20 shown in FIGS. 1-3, each pivot point 27 of each seat 14A, 14B, 14C (collectively 14) may be fixed in place (e.g., relative to the first linkage 16) by being mounted to a base structure 62A, 62B, 62C (collectively 62) via the second joint 22. The base structure 62 may include any suitable structure that holds the seats 14 stationary while the actuator 28 moves the first linkage 16, causing the seats 14 to pivot about a respective pivot point 27. Base structures may include beams, poles, columns, posts, or other similar structures. Moreover, instead of the couplings 24 shown in FIGS. 1-3, each seat 14 may be directly (e.g., without an intervening or intermediate component) and pivotably coupled to the first linkage 16 and a respective base structure 62. This may enable each seat 14 to pivot about a respective pivot point 27 without a coupling 24.

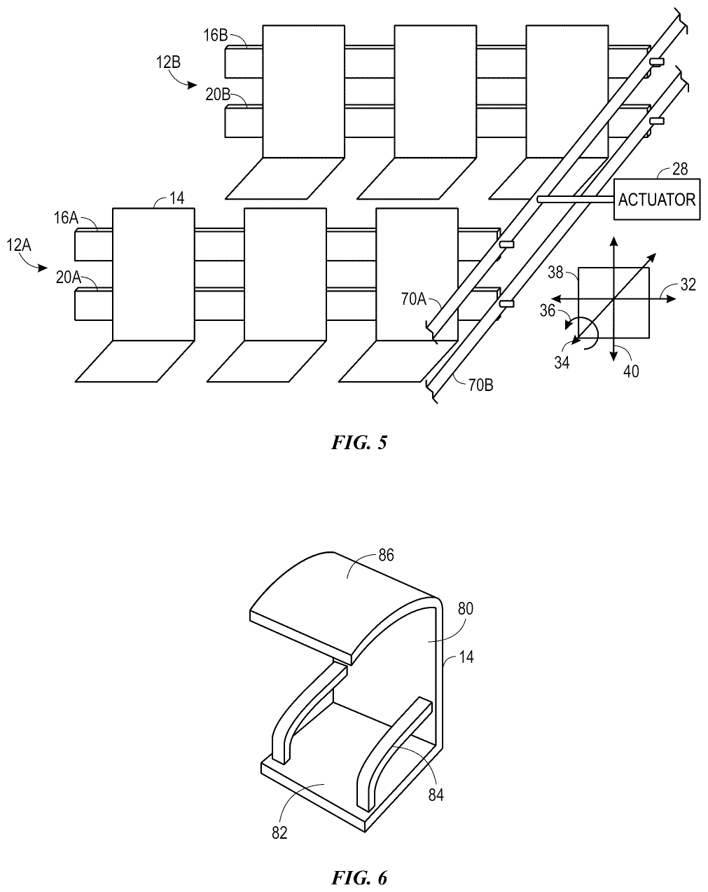

FIG. 5 is a perspective diagram of the amusement ride system 10 of FIG. 1 having multiple rows 12, according to an embodiment of the present disclosure. As illustrated, the amusement ride system 10 includes a first row 12A of multiple seats 14 (e.g., having a first set of linkages including a first linkage 16A and a second linkage 20A) and a second row 12B of multiple seats 14 (e.g., having a second set of linkages including a first linkage 16B and a second linkage 20B). It should be understood that the more than two rows 12 are contemplated (e.g., three or more rows, four or more rows, eight or more rows, ten or more rows, and so on). Each row 12A, 12B may be coupled to one another via any suitable coupling, such as one or more rails or structures 70A, 70B. In embodiments where the first linkages 16A, 16B are identical (e.g., straight, curved) and the second linkages 20A, 20B are identical, each seat 14 may rotate a same degree of rotation. In additional or alternative embodiments where the first linkages 16A, 16B are not identical or the second linkages 20A, 20B are not identical, certain seats 14 may rotate a different degree of rotation compared to other seats 14.

In some embodiments, less actuators 28 (e.g., a single actuator 28) than rows 12A, 12B may move or shift a first linkage 16A, 16B of each row 12A, 12B relative to a second linkage 20A, 20B of each row 12A, 12B. As such, the rails or structure 70A, 70B may translate movement of one first linkage (e.g., 16A) of one row (e.g., 12A) to another first linkage (e.g., 16B) of another row (e.g., 12B), thus enabling the smaller number of actuators 28 to move a greater number of rows 12. For example, as shown in FIG. 5, a single actuator 28 may be coupled to the first rail 70A and move the first rail 70 along a front-facing axis 34 (e.g., in a direction of a guest's view), causing the first linkages 16A, 16B to move along the horizontal axis 32 (e.g., in a direction along the rows 12A, 12B of the seats 14) transverse, orthogonal, or normal to the front-facing axis 34 along a plane 38 that is defined by the horizontal axis 32 and a vertical axis 40 of the seats 14 (e.g., that intersects both the first linkages 16A, 16B and the second linkages 20A, 20B), thus pivoting the seats 14 of both rows 12A, 12B. In additional or alternative embodiments, each row 12A, 12B may be coupled to a corresponding actuator 28, which may be controlled by a controller, that may move or shift each first linkage 16A, 16B of each row 12A, 12B. As noted above with respect to FIG. 4, in some embodiments, the amusement ride system 10 may not include the second linkages 20A, 20B, and instead each seat 14 may be pivotally mounted to a corresponding base structure. Likewise, each seat 14 may or may not include couplings 24.

FIG. 6 is a perspective diagram of a seat 14 of the amusement ride system 10 of FIG. 1, according to an embodiment of the present disclosure. In some embodiments, the seat 14 may include a back 80 and a base 82, such as shown in FIG. 1. In additional or alternative embodiments, and as illustrated in FIG. 6, the seat 14 may include arms 84 and/or a roof 86 (e.g., to shade a guest). Moreover, the seats 14 may include any suitable cushioning, restraint, safety features, and so on.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. § 112(f).

1. An amusement ride system comprising:
a plurality of seats, each seat of the plurality of seats having a pivot point pivotably coupled to a base structure;
a linkage pivotably coupled to each seat of the plurality of seats; and
an actuator coupled to the linkage.

2. The amusement ride system of claim 1, wherein the actuator is configured to cause each seat of the plurality of seats to pivot by moving the linkage.

3. The amusement ride system of claim 1, wherein the actuator is configured to cause each seat of the plurality of seats to pivot along a plane that is defined by a horizontal axis and a vertical axis of each seat of the plurality of seats.

4. The amusement ride system of claim 1, wherein each seat of the plurality of seats is pivotably coupled to the linkage via a first plurality of joints.

5. The amusement ride system of claim 4, wherein each seat of the plurality of seats is configured to pivot about a respective joint of a second plurality of joints.

6. The amusement ride system of claim 5, wherein the second plurality of joints pivotably couples each seat of the plurality of seats to a second linkage.

7. The amusement ride system of claim 6, wherein the linkage is parallel to the second linkage.

8. The amusement ride system of claim 6, wherein the linkage or the second linkage is curved.

9. The amusement ride system of claim 6, wherein the second linkage is fixed in place relative to the linkage.

10. The amusement ride system of claim 5, wherein the second plurality of joints pivotably couples each seat of the plurality of seats to a respective base structure.

11. An amusement ride system comprising:
a plurality of seats, each seat of the plurality of seats having a respective pivot point pivotably coupled to a base structure; and
an actuator coupled to each seat of the plurality of seats and configured to pivot each seat about the respective pivot point.

12. The amusement ride system of claim 11, wherein the actuator is pivot each seat along a plane that is defined by a horizontal axis and a vertical axis of each seat of the plurality of seats.

13. The amusement ride system of claim 11, wherein the actuator is configured to pivot each seat about a front-facing axis extending from a respective pivot point of each seat.

14. The amusement ride system of claim 11, wherein the actuator is coupled to a linkage that is coupled to each seat of the plurality of seats.

15. The amusement ride system of claim 14, wherein the actuator is configured to rock each seat from side-to-side by moving the linkage.

16. An amusement ride system comprising:
a first row of seats rotatably coupled to one another via a first linkage;
a second row of seats rotatably coupled to one another via a second linkage; and
a structure coupling the first linkage to the second linkage.

17. The amusement ride system of claim 16, comprising an actuator coupled to the structure.

18. The amusement ride system of claim 17, wherein the actuator is configured to move the structure along a front-facing axis of the first row of seats and the second row of seats.

19. The amusement ride system of claim 18, wherein moving the structure along the front-facing axis causes the first linkage and the second linkage to move a horizontal axis orthogonal to the front-facing axis.

20. The amusement ride system of claim 19, wherein moving the first linkage and the second linkage to move along the horizontal axis causes the first row of seats and the second row of seats to pivot.
